(19) United States
(12) Patent Application Publication
(10) Pub. No.: US 2025/0098639 A1
(43) Pub. Date: Mar. 27, 2025

(54) QUICK-RELEASE PET LEASHES AND LEASH/COLLAR SYSTEMS

(71) Applicant: BraunVest LLC, Charlotte, VT (US)

(72) Inventor: Frances K. Braun, Charlotte, VT (US)

(21) Appl. No.: 18/475,086

(22) Filed: Sep. 26, 2023

(51) Int. Cl. A01K 27/00

(52) U.S. Cl. CPC A01K 27/003

(57) ABSTRACT

Pet leashes and related systems. In some embodiments, the leash may comprise a distal section configured to selectively couple with a collar and a proximal section comprising a tether portion and a handle. A quick-release connector may be used to selectively couple and/or decouple the proximal section and the distal section to allow the distal section, which may comprise a handle, to be left coupled with a collar while the proximal section has been removed to allow the pet to run free and to facilitate quick and easy re-coupling of the proximal section as desired.

### SUMMARY

Embodiments of apparatus and methods are disclosed herein that relate to leashes and/or collars for dogs and other pets. In some embodiments disclosed herein, a leash may have various functional sections and/or portions, some of which may be releasable, preferably via quick-coupling/quick-release connectors, such as quick-release buckles, to allow for releasing a dog/pet and quickly reattaching the leash when control of the dog/pet is needed. In some embodiments, such functional sections/portions may include multiple handles of varying lengths, which may allow the dog/pet to be controlled at a variety of desired lengths depending upon circumstances. Some embodiments may also allow for a shorter portion of the leash, which may be left attached to a collar while a longer portion of the leash is detached and/or may comprise a handle, to be selectively affixed against the collar when not in use.

In a more specific example of a dog leash according to some embodiments, the leash may comprise a distal section, a proximal section, and an intermediate section. The distal section may comprise a connector piece positioned at a distal end of the distal section, which may be configured to couple with a collar. The distal section may further comprise a first quick-release connector positioned at a proximal end of the distal section. A fabric section, which may comprise a handle, in some cases a looped handle, may extend between the connector piece and the quick-release connector.

The intermediate section may comprise a second quick-release connector positioned at a distal end of the intermediate section. The second quick-release connector may be configured to couple with the first quick-release connector to selectively couple the intermediate section with the distal section. The intermediate section may further comprise an intermediate handle positioned at a proximal end of the intermediate section.

The proximal section may comprise a tether coupled to the intermediate handle, which may provide a primary length of the proximal section and, in some cases, of the leash as a whole. The proximal section may further comprise a proximal handle positioned at a proximal end of the proximal section. The intermediate handle may be configured to allow for maintaining control of the dog at an intermediate distance without use of the tether and/or proximal section.

In some embodiments, the first quick release connector and the second quick release connector may together define a quick-release buckle.

In some embodiments, the intermediate section may be non-releasably connected with the proximal section. For example, in some embodiments, the intermediate section may integrally extend from the proximal section, in some cases with one layer of the intermediate section extending therefrom to form a layer (in some cases, the only layer) of the proximal section.

In some embodiments, the distal section may be configured to selectively couple with a collar adjacent to the proximal end of the distal section to allow the distal section to be fixedly, but preferably removably, positioned against the collar when the distal section is decoupled from the intermediate section.

In some embodiments, the distal section may comprise a patch of hook and loop material, which may allow the distal section to be removably and/or fixedly coupled with the collar.

In some embodiments, the intermediate section may further comprise a non-looped portion extending between the second quick-release connector and the intermediate handle.

In a specific example of a pet leash according to other embodiments, the leash may comprise a distal section configured to selectively couple with a collar and a proximal section comprising a tether portion and a handle. The leash may further comprise a quick-release connector, such as a quick-release buckle, configured to allow for selective coupling of the proximal section with, and decoupling of the proximal section from, the distal section.

Some embodiments may further comprise additional handles, such as a second handle and, in some such embodiments, a third handle. In some embodiments, the second handle may be part of the distal section. In some embodiments, the third handle may be positioned at an intermediate point along the leash, in some cases within an intermediate section of the leash.

Some embodiments may further comprise an intermediate section positioned between the proximal section and the distal section. In some such embodiments, the intermediate section may comprise a second handle or, as mentioned above, the intermediate section may comprise a third handle.

In some embodiments, the intermediate section may integrally extend from the proximal section.

In some embodiments, one or more of the handles, such as the second handle, may be defined by a loop. In some embodiments, one or more sections may further comprise one or more non-looped sections. For example, the intermediate section may further comprise a non-looped section positioned distally of the loop.

In a specific example of a pet restraint system according to some embodiments, the system may comprise a collar and a leash. The leash may comprise a proximal handle and a distal handle. Some embodiments may further comprise an intermediate handle positioned between the proximal handle and the distal handle.

In embodiments comprising an intermediate handle, a first connector may be positioned distally of the intermediate handle, which first connector may be configured to couple with the distal handle. A second connector may be positioned at a proximal end of the distal handle, which second connector may be configured to couple with a portion of the leash comprising the proximal handle and, if present, the intermediate handle as well. In some embodiments, the first and second connectors may comprise separate pieces of a quick-release connector, such as a quick-release buckle.

In some embodiments, the distal handle may be configured to be selectively coupled with the collar adjacent to the proximal end of the distal handle. In some such embodiments, the collar may comprise a first coupling piece, and the distal handle may comprise a second coupling piece configured to selectively couple with the first coupling piece to allow the distal handle to be placed against the collar when the portion of the leash comprising the proximal handle (and, if present, the intermediate handle) is detached from the distal handle.

In some embodiments comprising first and second coupling pieces, the first coupling piece may comprise a first patch of hook and loop material, and the second coupling piece may comprise a second patch of hook and loop material. In other examples, the first and second coupling pieces may comprise snaps, adhesives, hooks, buttons, or the like.

The features, structures, steps, or characteristics disclosed herein in connection with one embodiment may be combined in any suitable manner in one or more alternative embodiments.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of a pet leash according to some embodiments;

FIG. 2 is a plan view of the pet leash of FIG. 1; and

FIGS. 3A and 3B are perspective views of a pet leash/collar system according to other embodiments.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure but is merely representative of possible embodiments of the disclosure. In some cases, well-known structures, materials, or operations are not shown or described in detail.

As used herein, the term “substantially” refers to the complete or nearly complete extent or degree of an action, characteristic, property, state, structure, item, or result to function as indicated. For example, an object that is “substantially” cylindrical or “substantially” perpendicular would mean that the object/feature is either cylindrical/perpendicular or nearly cylindrical/perpendicular so as to result in the same or nearly the same function. The exact allowable degree of deviation provided by this term may depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

Similarly, as used herein, the term “about” is used to provide flexibility to a numerical range endpoint by providing that a given value may be “a little above” or “a little below” the endpoint while still accomplishing the function associated with the range.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

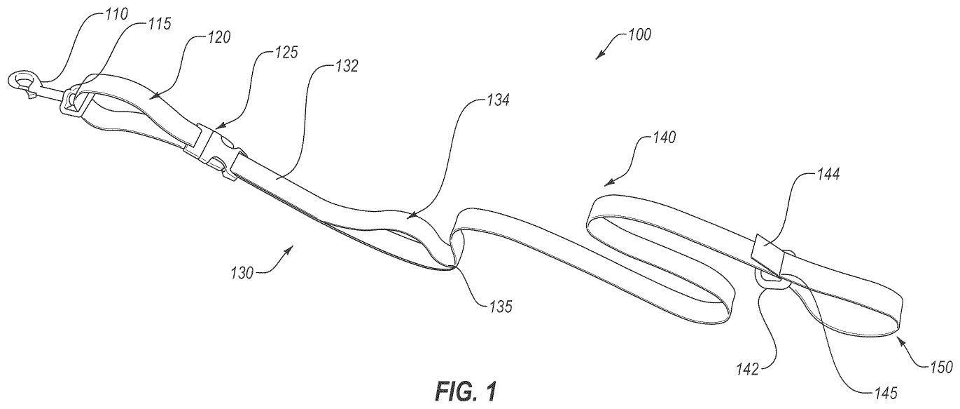

FIG. 1 depicts a leash 100 for a pet, such as a dog. Leash 100 comprises several functional sections or portions, including a distal section 120, which comprises a connector piece 110 positioned at a distal end of the distal section 120. The connector piece 110 is configured to couple with a collar (not shown) to secure the leash 100 to the collar. In preferred embodiments, connector piece 110 may comprise a snap hook and/or swivel hook having a rotatable coupling with an associated ring, such as a D-ring 115.

A loop of material, such as fabric material, may extend through the ring 115 and may be coupled at its proximal end with a quick-release connector 125. The loop defined by this material may therefore be used for and/or define a distal handle for the leash 100.

Preferably, the quick-release connector 125 is configured to allow a user to couple the distal section 120 with an adjacent section of leash 100, such as, for example, intermediate section 130, by a single step, such as simply advancing one portion of connector 125 towards another.

In some embodiments, the quick-release connector 125 therefore comprises a quick-release buckle, such as a quick-release buckle comprising a first quick-release connector piece and a second quick release connector piece that together define the quick-release buckle. For example, although FIG. 1 only depicts quick-release connector 125 in its coupled or connected state, it should be understood that this connector 125 comprises a male end, which may be non-releasably coupled with the aforementioned loop of distal section 120, and a corresponding female portion, which may be non-releasably coupled with the distal end of the adjacent section (intermediate section 130, in the depicted embodiment).

It is also preferred that a user be able to release connector 125, and thereby release the distal section 120 of leash 100 from the remainder of the leash 100, by a single action. Thus, in the depicted embodiment, a user can simply squeeze the opposing prongs of the quick-release buckle, which simultaneously forces the two pieces of the buckle apart to release them from one another.

Of course, the specific buckle depicted in the drawings and described herein is but an example of a quick-release connector. Other examples of suitable quick-release connectors include connectors having magnetic clasps pins, or other magnetic coupling/decoupling functionality, clasps, such as lobster clasps, and quick-release pin mechanisms.

Adjacent to the distal section 120 of leash 100 is an intermediate section 130. Intermediate section 130 comprises another quick-release connector positioned at a distal end of the intermediate section 130. In the depicted embodiment, the quick-release connector 125 at the distal end of intermediate section 130 comprises a portion (namely, a female portion) of the buckle 125 previously mentioned, which is positioned at the proximal end of the distal section 120.

Intermediate section 130 further comprises an intermediate handle 134, which is positioned at a proximal end of the intermediate section 130. In addition, in the depicted embodiment, a distal portion of intermediate section 130 adjacent to connector 125 comprises a non-looped portion 132. Non-looped portion 132 may, for example, be formed by sewing or otherwise affixing together the two layers of tether/fabric material defining the loop of handle 134.

This portion of the intermediate section 130 may serve several functions. For example, it may allow for placement of branding and/or a badge in this region of the leash 100. In addition, non-looped portion 132 may allow for selection of the length of the intermediate handle 134, which may provide a more ergonomic feel and/or may make it easier to control a dog or other pet from a shorter distance when, for example, crossing a road, being in the vicinity of other dogs/pets/humans, or when use of a longer leash would otherwise present a potential hazard for the dog/pet or other dogs/pets/humans, or when use of a shorter leash is otherwise desired.

The loop defining intermediate handle 134 may be defined at its distal end by non-looped portion 132, and at its proximal end by a fixed region 135. Fixed region 135 may, in some embodiments, be defined by simply sewing or otherwise affixing a top layer of tether and/or fabric defining intermediate handle 134 with a base layer of such tether and/or fabric.

However, it is also contemplated that, in some embodiments, the intermediate section 130 may be releasably coupled with a proximal section 140 of leash 100 at this location, such as by way of, for example, one or more hook and loop fabric pieces, snaps, hooks, fasteners, magnets, and the like. In addition, in some embodiments, the size of handle 134 may be adjustable. For example, in some embodiments, there may be a series of snaps or an elongated pair of hook and loop fabric sections to allow a user to adjust the size of the loop defining handle 134.

Proximal section 140 extends from intermediate section 130. As previously mentioned, in the depicted embodiment, proximal section 140 integrally and non-releasably extends from intermediate section 130, but this need not always be the case. Proximal section 140 comprises an elongate tether region, which extends from the fixed region 135 defining intermediate handle 134 to the proximal handle 150. In some embodiments, this tether may comprise one, continuous layer that may also define one of the layers (the bottom layer from the perspective of FIG. 1) of the intermediate section 130 and intermediate handle 134.

Proximal handle 150 is positioned at a proximal end of the proximal section 140. In some embodiments, proximal handle 150 may be defined by padded material to provide a more ergonomic grip for a user. For example, the proximal handle 150 may comprise, in some specific embodiments, a foam material or another relatively soft and pliable material, such as ethylene-vinyl acetate and/or polyurethane, which in some cases may be wrapped in neoprene. However, in other embodiments, the same base layer/material defining the tether of proximal section 140 and/or the bottom layer of intermediate section 130 may also be wrapped around and sewn or otherwise affixed to itself to define this loop, either with or without additional padding material.

At the distal end of the loop defining the proximal handle 150, a ring 142 and/or a tag 144 may be provided. Ring 142, which may comprise a D-ring in some embodiments, may allow the leash 100 to be coupled with another leash or other fixed object. Tag 144 may be used to place branding, labels, and/or pet identification information, if desired.

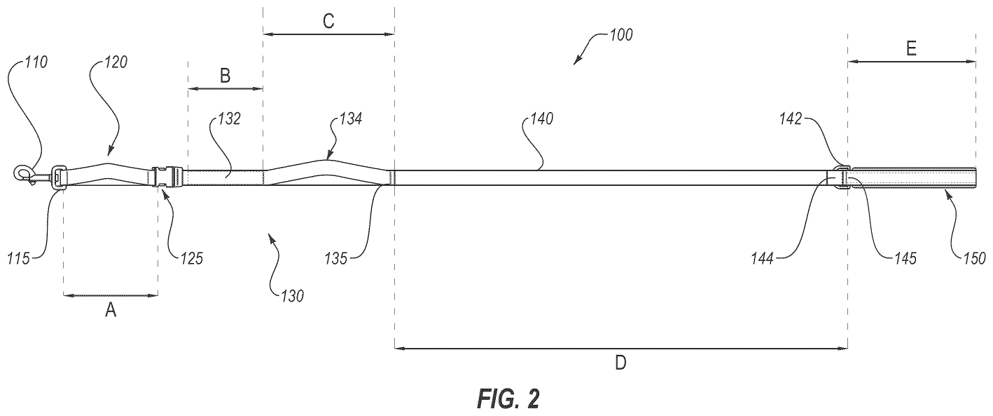

As shown in FIG. 2, in preferred embodiments, the various sections may have specific lengths and/or length ranges relative to one another. As shown in this figure, the distal section and/or handle 120 has a length A, the non-looped portion 132 has a length B, the intermediate handle 134 a length C (such that the intermediate section 130 has a length B+C), the tether region of the proximal section 140 has a length D, and the proximal handle 150 has a length E (such that the proximal section has a length D+E).

In preferred embodiments, each of the various handles may have a length that is the same, or at least similar. Thus, the proximal, intermediate, and distal handles may, in some embodiments, have a length of between about 5 and 10 inches. In some embodiments, however, the distal handle 120 may have a slightly smaller length than the intermediate handle 134, which may be slightly smaller in length than the proximal handle 150. Similarly, the intermediate handle 134 may have a slightly smaller length than both the proximal handle 150 and the distal handle 120, and the proximal handle 150 may also have a slightly smaller length than both the distal handle 120 and the intermediate handle 134 in some embodiments. In short, although all of the various handles may be the same size and/or length, it should be understood that all of the handles may vary in length from one another, as desired.

Preferably, the length of the tether section of proximal section 140 is substantially longer than the length of the other sections, which may allow for use of a full leash under normal circumstances. In some embodiments, the length of intermediate section 130 may be in between that of tether section 140 and distal section 120 and/or handle. Thus, in some embodiments, intermediate section 130 (length B+C) may be between about 10 and about 30% of the total length of the leash 100. Similarly, in some embodiments, distal section 120 and/or handle may have a length A that is between about 40 and about 60% of the length of intermediate section 130. However, it should be understood that some embodiments may lack an intermediate handle 134 and/or intermediate section 130 altogether.

The total length of leash 100 may also vary as desired, depending upon use and/or the type of dog/pet. For example, in some embodiments, the total length will vary, and may be offered in various sizes, between about 4 feet in length and about 6 feet in length, in some cases in sizes that vary every foot or so. The distal handle 120, also referred to herein as a “dongle,” may also vary in size and/or configuration depending upon the length. For example, for medium or large leashes of 5-6 feet, the dongle may be about 6 inches in length, in which case the intermediate handle may be, for example, 6-8 inches in length and the proximal handle may be, for example, 6-9 inches in length. For smaller leashes, such as those between 4-5 feet, the distal handle 120 or dongle may be between 3-4 inches, in which case the intermediate handle, if present, may be 3-5 inches and the proximal handle may be 3-8 inches in length. In some embodiments, smaller leashes may comprise a proximal handle/dongle that does not define a loop, but rather only provides a tab that must be gripped without providing an internal loop for the handle, which may be sufficient for smaller dogs/pets.

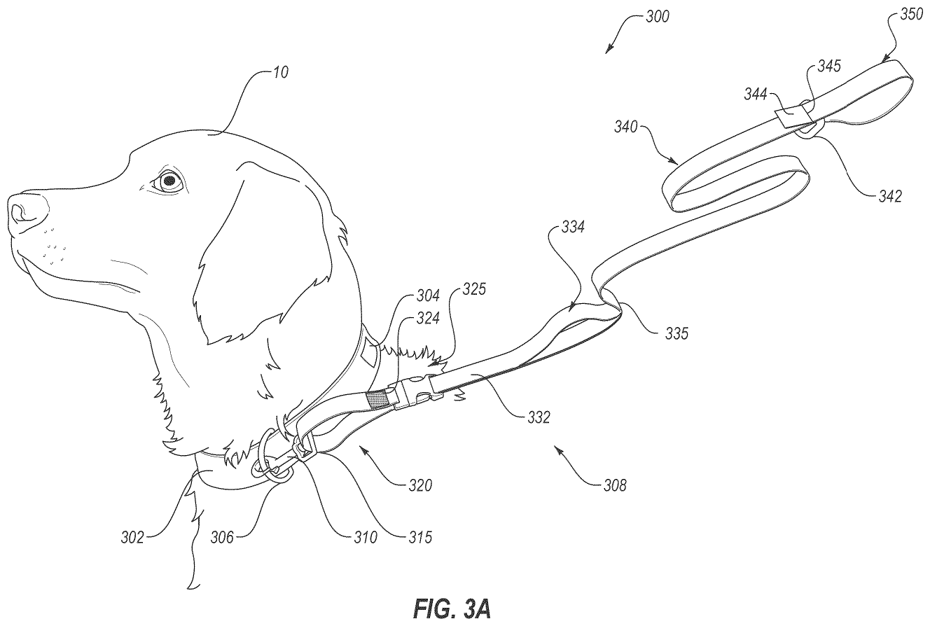

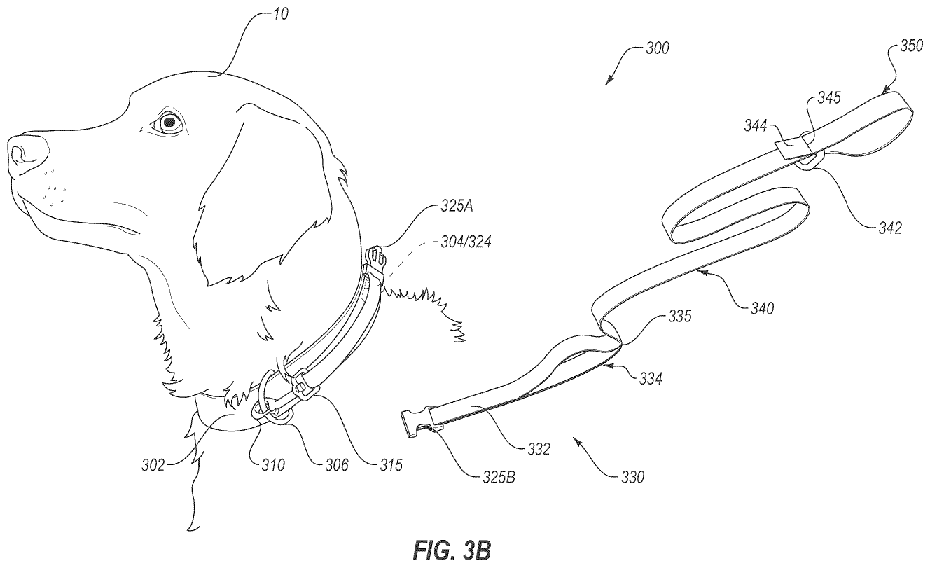

FIGS. 3A and 3B depict an alternative embodiment of a leash/collar system 300 that includes a collar 302 for a dog 10 and a leash 308. As with leash 100, leash 308 may include various functional sections, including a distal section 320, which may define a distal handle or dongle that may be detachable from the remainder of the leash 308. This distal handle defines a loop that extends through a ring 315, such as a rotatable D-ring, which may be coupled with a connector piece 310 positioned at a distal end of the distal section 320. The connector piece 310 is configured to couple with a corresponding ring 306 on collar 302 to secure the leash 308 to the collar 302.

A loop of material, such as fabric material, extends through the ring 315 and is coupled at its proximal end with a quick-release connector 325. As shown in FIG. 3B, connector 325 comprises a male connector or buckle piece 325A and a female connector or buckle piece 325B to provide a means for quickly coupling and/or decoupling the distal section 320 and/or dongle from the remainder of leash 308.

More particularly, piece 325A is part of the detachable, distal section 320 of leash 308 and piece 325B is part of the intermediate section 330 of leash 308 at the distal end of the portion of leash 308 that can be detached as distal section 320 remains on collar 302. However, of course, pieces 325A and 325B may be reversed and/or replaced with alternative coupling pieces/features in alternative embodiments. Similarly, some embodiments may include a proximal section of a leash without a function intermediate section.

However, in the depicted embodiment, leash 308 further comprises an intermediate section 330, which may comprise a non-looped portion 332 and an intermediate handle 334, which may terminate at its proximal end by fixed region 335. A proximal section 340 extends from intermediate section 330. Proximal section 340 includes an elongate tether portion, which extends from the fixed region 335 defining intermediate handle 334 to a proximal handle 350.

Proximal handle 350 is positioned at a proximal end of the proximal section 340. At the distal end of the loop defining the proximal handle 350, a ring 342 and/or a tag 344 may be provided, as previously described, in some embodiments.

Collar 302 and leash 308 further comprises a feature that allows the distal section 320 of leash 308 to be selectively coupled with and, in some cases, fixedly positioned against collar 302 once the remaining portion of leash 308 has been detached from distal section 320. More particularly, as shown in FIG. 3A, a first coupling piece 304 is provided on the collar 302, and a corresponding second coupling piece 324 is provided on the distal section 320 and/or handle of the leash 308.

The first coupling piece 304 and the second coupling piece 324 are configured to be selectively coupled with one another to allow the distal section 320 and/or distal handle to be fixedly placed against the collar 302 when the distal section 320 and/or distal handle have been uncoupled from the remaining proximal portion(s) of the leash 308, as shown in FIG. 3B.

In the depicted embodiment, the first and second coupling pieces 304/324 comprise respective patches of hook and loop material that can be easily coupled with one another to allow the distal section 320 and/or distal handle to be selectively coupled and uncoupled with the collar 302 to allow this section of system 300 to be conveniently placed against the collar to avoid having it flap against the dog 10 when the proximal portion(s) of the leash 308 have been decoupled during, for example, free/play time. It may therefore be preferable to position the second coupling piece 324 adjacent to a proximal end of the distal section 320 and/or handle, which may ensure that the entire section 320 lays flat against the collar 302.

This may also conveniently allow a user to remove distal section 320 from the collar 302 to be used as a very short handle for short-range control of the dog 10. Similarly, when it is desired that the proximal portion of the leash 308 be reattached, coupling pieces 304/324 can simply be decoupled from one another to facilitate ease of recoupling of connector pieces 325A and 325B. Of course, this can be accomplished with the distal section 320 lying against and coupled with leash 302 along its entire length with coupling pieces 304/324 attached, if desired.

It should be understood, however, that the use of hook and loop material for the two coupling pieces 304/324 is but an example. Other examples of other potentially suitable coupling pieces for this purpose include snaps, pins, buttons, adhesives, buckles, loops, and the like.

In addition, in some embodiments, features may be added to make it easier to see the distal section, distal handle, and/or dongle. For example, in some embodiments, one or both of the coupling pieces 304/324 may include reflective and/or glow-in-the-dark material and/or lights. In addition, or as an alternative, the distal section, distal handle, and/or dongle itself may be made from such materials, which may improve the ability of older, handicapped, and/or impaired persons to manage their pets more easily, particularly in dark lighting conditions.

It will be understood by those having skill in the art that changes may be made to the details of the above-described embodiments without departing from the underlying principles presented herein. Any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. The scope of the present invention should, therefore, be determined only by the following claims.

1. A dog leash, comprising:
a distal section comprising:
a connector piece positioned at a distal end of the distal section, the connector piece being configured to couple with a collar;
a first quick-release connector positioned at a proximal end of the distal section; and
a fabric section extending between the connector piece and the quick-release connector;
an intermediate section comprising:
a second quick-release connector positioned at a distal end of the intermediate section, the second quick-release connector configured to couple with the first quick-release connector to selectively couple the intermediate section with the distal section; and
an intermediate handle positioned at a proximal end of the intermediate section; and
a proximal section comprising:
a tether coupled to the intermediate handle; and
a proximal handle positioned at a proximal end of the proximal section, wherein the intermediate handle is configured to allow for maintaining control of the dog at an intermediate distance without use of the tether.

2. The dog leash of claim 1, wherein the first quick release connector and the second quick release connector together define a quick-release buckle.

3. The dog leash of claim 1, wherein the fabric section defines a distal handle.

4. The dog leash of claim 1, wherein the intermediate section is non-releasably connected with the proximal section.

5. The dog leash of claim 1, wherein the distal section is configured to selectively couple with a collar adjacent to the proximal end of the distal section to allow the distal section to be fixedly positioned against the collar when the distal section is decoupled from the intermediate section.

6. The dog leash of claim 5, wherein the distal section comprises a patch of hook and loop material.

7. The dog leash of claim 1, wherein the intermediate section further comprises a non-looped portion extending between the second quick-release connector and the intermediate handle.

8. A pet leash, comprising:
a distal section configured to selectively couple with a collar;
a proximal section comprising a tether portion and a handle; and
a quick-release connector configured to allow for selective coupling of the proximal section with, and decoupling of the proximal section from, the distal section.

9. The pet leash of claim 8, wherein the quick release connector comprises a quick release buckle.

10. The pet leash of claim 8, further comprising a second handle.

11. The pet leash of claim 10, wherein the second handle is part of the distal section.

12. The pet leash of claim 10, further comprising a third handle.

13. The pet leash of claim 8, further comprising an intermediate section positioned between the proximal section and the distal section, wherein the intermediate section comprises a second handle.

14. The pet leash of claim 13, wherein the intermediate section integrally extends from the proximal section.

15. The pet leash of claim 13, wherein second handle is defined by a loop, and wherein the intermediate section further comprises a non-looped section positioned distally of the loop.

16. A pet restraint system, comprising:
a collar; and
a leash comprising:
a proximal handle;
a distal handle;
an intermediate handle positioned between the proximal handle and the distal handle;
a first connector positioned distally of the intermediate handle, the first connector being configured to couple with the distal handle; and
a second connector positioned at a proximal end of the distal handle, the second connector being configured to couple with a portion of the leash comprising the proximal handle and the intermediate handle.

17. The pet restraint system of claim 16, wherein the distal handle is configured to be selectively coupled with the collar adjacent to the proximal end of the distal handle.

18. The pet restraint system of claim 17, wherein the collar comprises a first coupling piece, and wherein the distal handle comprises a second coupling piece configured to selectively couple with the first coupling piece to allow the distal handle to be placed against the collar when the portion of the leash comprising the proximal handle and the intermediate handle is detached from the distal handle.

19. The pet restraint system of claim 18, wherein the first coupling piece comprises a first patch of hook and loop material, and wherein the second coupling piece comprises a second patch of hook and loop material.

20. The pet restraint system of claim 16, wherein the first connector and the second connector together define a quick-release connector.
